(19) United States
(12) Patent Application Publication
(10) Pub. No.: US 2025/0317545 A1
(43) Pub. Date: Oct. 9, 2025

(54) OPTOELECTRONIC MODULE

(71) Applicant: ams International AG, Jona (CH)

(72) Inventors: Francesco Paolo D'ALEO, Samstagern (CH); Jens GEIGER, Thalwil (CH)

(21) Appl. No.: 18/865,351

(22) PCT Filed: May 5, 2023
(86) PCT No.: PCT/EP2023/062047

§ 371 Date: Nov. 13, 2024

(30) Foreign Application Priority Data
May 18, 2022 (GB) 2207253.2

(51) Int. Cl. H04N 13/254; H04N 13/156; H04N 23/11; H04N 23/56; H04N 23/74

(52) U.S. Cl. CPC H04N 13/254; H04N 13/156; H04N 23/11; H04N 23/56; H04N 23/74

(57) ABSTRACT

An optoelectronic module (100) and a method of manufacturing an optoelectronic module the optoelectronic module comprising: an illuminator (102) comprising a plurality of light sources (104) configured to emit light towards a scene at an illumination wavelength; a detector layer (106) configured to detect light having the illumination wavelength reflected by the scene; a mask layer (108) disposed over the detector layer, the mask layer being configured to interact with light having the illumination wavelength; and a processor (110), the processor configured to: modulate the plurality of light sources; and reconstruct an image of the scene.

### CROSS-REFERENCE TO RELATED APPLICATIONS

This is a national phase of International Application PCT/EP2023/062047, which was filed on May 5, 2023, and which claims priority to British Application GB 2207253.2, which was filed on May 18, 2022, the entire contents of each of which are incorporated herein by reference.

### TECHNICAL FIELD

The present disclosure relates to an optoelectronic module comprising an illuminator.

### BACKGROUND

Optimal Integration time of cameras is the trade-off between minimising the collection of noise and gathering sufficient photons. If an object is too close, the signal increases to saturation. To overcome this, normally either the integration time must be reduced, leading to an increase in noise, or the light source intensity must be reduced, reducing the object distance range.

### SUMMARY

The present disclosure relates to an optoelectronic module comprising an illuminator. In particular, the optoelectronic module according to the present disclosure may form part of e.g. a lensless camera and/or display system. In some examples, the optoelectronic module according to the present disclosure may be particularly suitable for ranging, 3-dimensional (3D) imaging, and/or for motion and/or gesture sensing.

In some examples, an optoelectronic module according to the present disclosure may form part of a portable communications device such as a mobile phone, laptop, tablet, smart watch, etc.

In conventional cameras, during exposure, the image sensor integrates the arriving signal over the exposure time and so an image of a moving object appears blurred. The illuminator according to the present disclosure can be controlled such that light directed at a scene to be imaged may be modulated, or “coded”. By illuminating the scene with modulated illumination, the images of moving objects can be effectively deblurred, and/or the motion may be “decoded”.

According to one aspect of the present disclosure there is provided an optoelectronic module comprising: an illuminator comprising a plurality of light sources configured to emit light towards a scene at an illumination wavelength; a detector layer configured to detect light having the illumination wavelength reflected by the scene; a mask layer disposed over the detector layer, the mask layer being configured to interact with light having the illumination wavelength; and a processor, the processor configured to: modulate the plurality of light sources; and reconstruct an image of the scene.

Preferably, the illuminator is integral to the optoelectronic module.

The light sources may comprise, for example, light emitting diodes (LEDs) and/or vertical-cavity surface-emitting lasers (VCSELs).

In some examples, the mask layer may comprise a pattern configured to block light having the illumination wavelength. In some examples, the mask layer may comprise a phase mask and/or an amplitude mask. In some examples, the mask layer may form a “coded aperture”.

Advantageously, the modulated light sources of the illuminator enable improved imaging of moving objects, or of scenes where the optoelectronic module is moving relative to the scene to be imaged, by reducing the blurring effects of the above-mentioned integration in conventional cameras. In some examples, the processor may be configured to synchronize detection by the detector layer with the modulation of the light sources. In some examples, the modulated illumination may further advantageously enhance a signal-to-noise ratio (SNR) of the detected image, similar to a lock-in amplification technique.

In some examples, the optoelectronic module may further comprise a display.

An optoelectronic module according to the present disclosure may form part of a lensless camera and/or display system. Advantageously, the use of a mask layer (also referred to as a “coded” mask layer) in place of a classical lens system provides a thinner optoelectronic module (since the mask layer generally has a flat form factor), which may be better suited for integration into e.g. portable communications devices such as mobile phones, laptops, tablets, smart watches, etc. The use of lensless optics (i.e. a mask layer) also prevents distortion of the display of a portable communications device where the mask layer is disposed over said display.

Furthermore, in contrast to a classical lens-based system, a system based on a mask layer is angle insensitive and so may be better suited to applications such as gesture sensing.

In general, interaction with the light having the illumination wavelength may comprise modulation of the intensity, phase, and/or polarization of said light having the illumination wavelength.

In some examples, the plurality of light sources of the illuminator may be disposed around a periphery of the optoelectronic module, e.g. forming a ring illuminator. Having the light sources disposed around a periphery of the optoelectronic module may advantageously facilitate easier integration of the illuminator with the optoelectronic module, and/or may reduce crosstalk and/or may prevent interference with the optical path.

In some examples, the illuminator may be in the form of a layer (i.e. an illuminator layer). For example, the illuminator layer may comprise a layer of a material that is transparent to the illumination wavelength, and the illuminator layer may further comprise a plurality of light sources distributed on and/or in the layer of material, e.g. around a periphery of the layer of material.

Advantageously, the optoelectronic module according to the present disclosure comprising a plurality of layers (i.e. detector layer, mask layer, display layer in some examples, illuminator layer in some examples, etc.) facilitates a simplified manufacturing process in which the plurality of layers can simply be disposed (e.g. stacked) one on top of another. Furthermore, the stackable layers may advantageously provide a thinner optoelectronic module in comparison to the prior art.

In some examples, the plurality of light sources may be modulated randomly.

In some examples, the illuminator may be disposed over the mask layer.

In some examples, the illuminator may be integrated with the detector layer. For example, the illuminator and the detector layer may be combined in a single layer. For example, the plurality of light sources may be disposed around a periphery of the detector layer.

In some examples, the detector layer may be integrated with a display layer. For example, the detector layer may be integrated with a display layer forming part of a display for a portable communications device such as a mobile phone, tablet, smart watch, or laptop.

In some examples, a display layer may comprise an LED display such as an organic light emitting diode (OLED) display or a microLED display.

In some examples, the mask layer may be configured to be transmissive to visible light. In other words, for example, the mask layer may be configured not to interact with visible light. A mask layer configured to be transmissive to visible light may advantageously enable light from, e.g., a display or display layer to be transmitted without undergoing any distortion or interference that might otherwise be caused by interacting with the mask layer.

In some examples, the illumination wavelength may be an infrared wavelength. For example, the illumination wavelength may be around 850 nm or around 940 nm. It will be understood that the illumination wavelength may be optimized for a particular intended application. Advantageously, infrared light is invisible and so would not affect a user's ability to view a display of a device including the optoelectronic module according to the present disclosure.

In some examples, the mask layer may comprise a uniformly redundant array or a modified uniformly redundant array.

In some examples, the mask layer may comprise a controllable, or “active”, mask. In other words, the controllable mask may enable reconfiguration of a mask pattern. The processor may be further configured to control the controllable mask. For example, the processor may be configured to change a pattern of the mask layer, e.g. to enable time multiplexing.

In some examples, the controllable mask may comprise one or more of: a liquid crystal display; a plurality of vanadium oxide transistors; and/or a digital micromirror device (e.g. a digital light processor).

In some examples, the mask layer may comprise a passive mask, e.g. a mask having a pattern that cannot be reconfigured.

In some examples, a pattern on the mask layer may be formed from one or more dye-based polymers.

In some examples, the processor may be further configured to modulate each of the plurality of light sources individually. In some examples, different groups of light sources of the plurality of light sources may be modulated separately. For example, in the case of a ring illuminator as described herein, or any other illuminator in which the light sources are spatially distributed about the optoelectronic module, modulating the light sources individually may enable illumination of a scene from different angles separately, which may be used to generate images of a scene illuminated from different angles.

In some examples, the processor may be further configured to apply an iterative phase retrieval algorithm to the plurality of images of the scene. The processor may be further configured to generate a complex-valued object image of the scene. A complex-valued object image may include both intensity and phase properties, and may enable very high-resolution, or super-resolution, imaging. In other words, a higher resolution may be achieved than that provided by the field-of-view and the system resolution (e.g. sensor pitch and mask resolution).

In some examples, the processor may be further configured to determine a 3D reconstruction of the scene from a plurality of images (i.e. through a photometric stereo technique), e.g. from the plurality of images generated when the scene is illuminated from different angles. The 3D reconstruction of the scene may enable, for example, facial and/or gesture recognition.

In some examples, the processor may be further configured to: determine an intensity of the light detected by the detector layer; and to vary a power of the plurality of light sources based on the intensity of the light detected by the detector layer. By feeding back the intensity of light detected by the detector layer, the power emitted by the illuminator can be adjusted in order to vary the range of the optoelectronic module. For example, the detector layer may have an optimum gain and/or an optimum integration time, at which the SNR is optimized or maximized. By varying the power emitted by the illuminator instead of varying the gain and/or the integration time of the detector layer, the optimum, or maximum, SNR can be maintained.

In some examples, the illuminator power may be varied by pulse width modulation.

According to another aspect of the present disclosure there is provided a method of manufacturing an optoelectronic module, the method comprising: forming an illuminator, the illuminator comprising a plurality of light sources configured to emit light towards a scene at an illumination wavelength; disposing a detector layer in the optoelectronic module, the detector layer being configured to detect light having the illumination wavelength reflected by the scene; disposing a mask layer over the detector layer, the mask layer being configured to interact with light having the illumination wavelength; and configuring a processor to: modulate the plurality of light sources; and reconstruct an image of the scene.

Preferably, the illuminator is formed integrally with the optoelectronic module.

The light sources may comprise, for example, light emitting diodes (LEDs) and/or vertical-cavity surface-emitting lasers (VCSELs).

In some examples, the mask layer may comprise a pattern configured to block light having the illumination wavelength. In some examples, the mask layer may comprise a phase mask and/or an amplitude mask. In some examples, the mask layer may form a “coded aperture”.

Advantageously, the modulated light sources of the illuminator of an optoelectronic module manufactured according to the method described herein enable improved imaging of moving objects, or of scenes where the optoelectronic module is moving relative to the scene to be imaged, by reducing the blurring effects of the above-mentioned integration in conventional cameras. In some examples, the processor may be configured to synchronize detection by the detector layer with the modulation of the light sources. In some examples, the modulated illumination may further advantageously enhance a signal-to-noise ratio (SNR) of the detected image, similar to a lock-in amplification technique.

An optoelectronic module manufactured according to the method of the present disclosure may form part of a lensless camera and/or display system. Advantageously, the use of a mask layer (also referred to as a “coded” mask layer) in place of a classical lens system provides a thinner optoelectronic module, which may be better suited for integration into e.g. portable communications devices such as mobile phones, laptops, tablets, smart watches, etc. Furthermore, in contrast to a classical lens-based system, a system based on a mask layer is angle insensitive and so may be better suited to applications such as gesture sensing.

In some examples, forming the illuminator may comprise disposing the plurality of light sources of the illuminator around a periphery of the optoelectronic module, e.g. forming a ring illuminator. Having the light sources disposed around a periphery of the optoelectronic module may advantageously facilitate easier integration of the illuminator with the optoelectronic module, and/or may reduce crosstalk and/or may prevent interference with the optical path.

In some examples, forming the illuminator may comprise forming said illuminator in the form of a layer (i.e. an illuminator layer). For example, the illuminator layer may comprise a layer of a material that is transparent to the illumination wavelength, and the illuminator layer may further comprise a plurality of light sources distributed on and/or in the layer of material, e.g. around a periphery of the layer of material.

Advantageously, the optoelectronic module manufactured according to the method of present disclosure comprises a plurality of layers (i.e. detector layer, mask layer, display layer in some examples, illuminator layer in some examples, etc.), and so facilitates a simplified manufacturing process in which the plurality of layers can simply be disposed (e.g. stacked) one on top of another. Furthermore, the stackable layers may advantageously provide a thinner optoelectronic module in comparison to the prior art.

### BRIEF DESCRIPTION OF THE DRAWINGS

Some embodiments of the disclosure will now be described by way of example only and with reference to the accompanying figures, in which:

FIG. 1 illustrates a first example of an optoelectronic module according to the present disclosure;

FIG. 2 illustrates a second example of an optoelectronic module according to the present disclosure;

FIG. 3 illustrates a third example of an optoelectronic module according to the present disclosure;

FIG. 4 illustrates a fourth example of an optoelectronic module according to the present disclosure; and

FIG. 5 illustrates a method of manufacturing an optoelectronic module according to the present disclosure.

### DETAILED DESCRIPTION

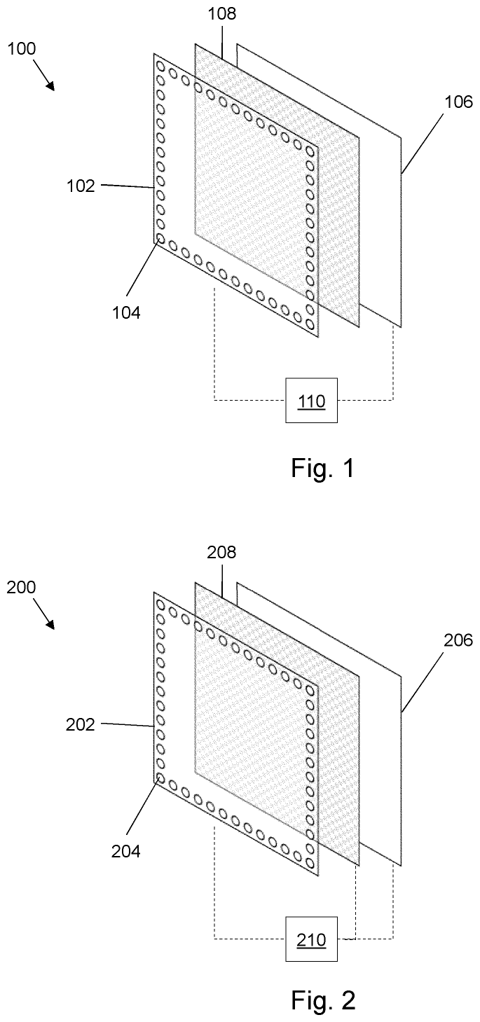

FIG. 1 illustrates an exploded view of a first example of an optoelectronic module 100 according to the present disclosure.

The optoelectronic module 100 illustrated in FIG. 1 comprises an illuminator 102, the illuminator 102 comprising a plurality of light sources 104, a detector layer 106, and a mask layer 108 disposed over the detector layer 106. In the non-limiting examples illustrated herein, the illuminator 102 also has a general form factor of a layer, and the detector layer 106, mask layer 108, and illuminator 102 are all stacked one on top of the other to provide an optoelectronic module 100 having a thin profile.

In the example illustrated in FIG. 1, the mask layer 108 is disposed between the illuminator 102 and the detector layer 106.

The light sources 104 of the illuminator 102 may comprise, for example, LEDs (e.g. OLEDs and/or microLEDs), and/or VCSELS, and may be distributed around a periphery of a layer of material (e.g. transparent material) to form the illuminator 102 (e.g. a ring illuminator). The light sources 104 are generally arranged to emit light (e.g. infrared light) towards a scene (not shown), i.e. to emit light in a direction away from the detector layer 106. In general herein, the wavelength of the light emitted by the light sources 104 is referred to as an illumination wavelength.

The detector layer 106 is configured to detect light having the illumination wavelength, which light is reflected by objects in the illuminated scene. For example, the detector layer 106 may comprise one or more light sensitive elements operable to produce a signal in response to a received dose of radiation having the illumination wavelength (i.e. to convert the received radiation dose into electrical signals). For example, the detector layer may be based on an active-pixel sensor technology and may comprise, for example, an array of complimentary metal-oxide semiconductor (CMOS) pixels.

The mask layer 108 is configured to interact with light having the illumination wavelength, and in general comprises a mask pattern configured to block some of the light having the illumination wavelength. The mask layer may comprise a phase mask and/or an amplitude mask. For example, the mask pattern may comprise a set of pinholes and/or act as a coded aperture. In some examples, the mask pattern may comprise a Moiré pattern and/or a diffractive pattern. More generally, it will be understood that some areas of the mask layer (i.e. the mask pattern of the mask layer) interact with light having the illumination wavelength, and other areas of the mask layer allow the light having the illumination wavelength to pass through without any interaction.

In some examples, in the case of an amplitude mask, the mask layer 108 comprises a diffusive material (at the illumination wavelength), provided that the point spread function of the optoelectronic module can be measured.

In some examples, the mask layer (or mask pattern) may comprise a regular pattern such as a uniformly redundant array or a modified uniformly redundant array. In some examples, the mask pattern may comprise a random or pseudo-random pattern, an m-sequence, or any other pattern.

In the example illustrated in FIG. 1, the mask layer 108 is a passive mask layer.

The mask layer 108 may comprise a dye-based polymer, such as SIR850W, SIR850N, or SIR940 (all produced by Fujifilm (®)), deposited in a pattern. The dye-based polymer is generally patterned using standard photolithographic techniques.

The optoelectronic module 100 further comprises a processor 110. In some examples, the processor 110 comprises a processor (e.g. a central processing unit (CPU)) of a portable communications device (e.g. a mobile phone).

The processor 110 is connected to the illuminator 102 and the detector layer 106.

The processor 110 is configured to modulate the plurality of light sources 104. For example, the processor 110 can be configured to cause the plurality of light sources 104 to switch on and off in order to expose the scene to light having the illumination wavelength for a short time. In some examples, modulating the light sources 104 may comprise varying a power of the light sources 104. In some examples, the processor 110 may be configured to modulate all of the light sources 104 in the same way at the same time. In some examples, the processor 110 may be configured such that each of the light sources 104 can be modulated individually. For example, the light sources 104 may be distributed such that the scene is illuminated from a different angle depending on the position of the active light source 104 (e.g. depending on the side of the ring illuminator on which the active light source 104 is situated), and the processor 110 may be configured to modulate different light sources 104 or different groups of light sources 104 to vary the angle of illumination.

The processor 110 is further configured to reconstruct an image of the scene, e.g. based on the electrical signals generated by the detector layer 106 and on the known mask pattern. For example, the processor 110 may apply an algorithm (such as a deconvolution algorithm) to the image (i.e. signals) generated by the detector layer 106 to reconstruct the image of the scene. In some examples, the processor 110 may be configured to reconstruct an image of the scene based on a convolutional neural network. In some examples, the processor 110 may be configured to apply a specialised machine learning algorithm to reconstruct the image of the scene.

In conventional cameras, moving objects or moving cameras cause motion blur in a captured image. During the exposure time, the image sensor (e.g. detector) integrates the arriving signal (generated upon the detection of light) over the exposure time, and therefore the final image appears blurred. This is equivalent to a box filter that acts in time by averaging the signal and destroying the high frequency details. By modulating (or “coding”) the illumination light (which may be, in some examples, modulated randomly), this effectively acts as a broadband filter that preserves the high frequencies and reduces image blur. Furthermore, modulating the light sources 104 enhances the SNR of the detected image(s). In some examples, the processor 110 may be configured to synchronize the detection by the detector layer 106 with the modulation of the light sources 104 in a lock-in amplifier fashion to enhance the SNR further.

In examples where the light sources 104 can be individually modulated or controlled, it may be possible to achieve so-called super-resolution, i.e. a higher resolution than is achieved by only considering the field of view and the system resolution (sensor pitch and mask resolution). In an example, the illuminator 102 successively illuminates the scene from different incident angles. At each angle, the processor 110 records a (low-resolution) intensity image that corresponds to the information from different Fourier k-space. All captured images are transformed in the Fourier domain in an iterative phase retrieval process (e.g. Gerchberg-Saxton algorithm). The information in the Fourier domain then generates a high-resolution complex-valued object image that includes both intensity and phase properties. This technique may further advantageously enable computational correction (e.g. by the processor 110) of optical aberrations post-measurement.

Furthermore, in examples where the light sources 104 can be individually modulated or controlled, it may be possible to reconstruct a 3D image of the scene by illuminating the scene from different angles and applying e.g. a photometric stereo technique. The processor 110 may therefore be further configured to reconstruct a 3D image of the scene from a plurality of images of the scene illuminated from different angles. In some examples, reconstructing a 3D image of the scene may comprise estimating a surface normal of one or more objects in the scene.

In some examples, the processor 110 may be configured to adjust (or vary) a power of one or more of the light sources 104 based on a determined intensity of the light detected by the detector layer 106, e.g. in order to vary a range of the optoelectronic module (e.g. a distance range within which an image of the scene can be successfully obtained). For example, the processor 110 may be configured to adjust the power of one or more of the light sources 104 to maintain an optimal SNR when the distance to the scene changes. In some examples, the power of the light source(s) 104 may be varied by pulse width modulation.

The processor 110 may be configured to carry out one or more of the functions or methods described herein by executing a set of instructions stored in one or more computer readable memory devices (e.g. as program code). For example, the instructions may be provided on one or more carriers. For example there may be one or more non-transient memories, e.g. a EEPROM (e.g. a flash memory) a disk, CD- or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language.

FIG. 2 illustrates an exploded view of a second example of an optoelectronic module 200 according to the present disclosure.

The optoelectronic module 200 illustrated in FIG. 2 comprises an illuminator 202, the illuminator 202 comprising a plurality of light sources 204, a detector layer 206, a mask layer 208 disposed over the detector layer 206, and a processor 210 connected to the illuminator 202 and the detector layer 206. The illuminator 202 (including the plurality of light sources 204), the processor 210, and the detector layer 206 are substantially similar to like components of the optoelectronic module 100 illustrated in FIG. 1 and described hereinabove.

In contrast to the optoelectronic module 100 illustrated in FIG. 1, the optoelectronic module 200 illustrated in FIG. 2 comprises a controllable (or “active”) mask layer 208. That is, the mask layer 208 illustrated in FIG. 2 comprises a mask pattern that is reconfigurable. For example, the mask pattern of the mask layer 208 may be reconfigured according to a particular application. The controllable mask layer 208 may be implemented, for example, through a liquid crystal display, a plurality of vanadium oxide transistors, and/or a digital micromirror device. As further illustrated in FIG. 2, the processor 210 is additionally connected to the controllable mask layer 208 and is further configured to control the controllable mask layer, e.g. to adjust the mask pattern as required.

The controllable mask layer 208 may, in some implementations, enable time multiplexing of images.

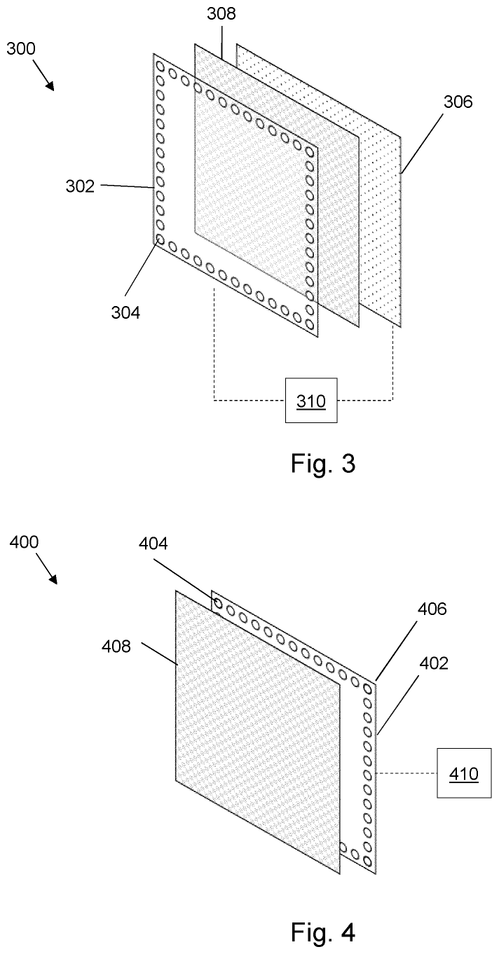

FIG. 3 illustrates an exploded view of a third example of an optoelectronic module 300 according to the present disclosure.

The optoelectronic module 300 illustrated in FIG. 3 comprises an illuminator 302, the illuminator 302 comprising a plurality of light sources 304, a detector layer 306, a mask layer 308 disposed over the detector layer 306, and a processor 310 connected to the illuminator 302 and the detector layer 306. The illuminator 302 (including the plurality of light sources 304), the mask layer 308, and the processor 310 are substantially similar to like components of the optoelectronic module 100 illustrated in FIG. 1 and described hereinabove.

In the example illustrated in FIG. 3, the detector layer 306 is integrated with a display layer (e.g. a bidirectional display). For example, detector layer 306 may comprise a backplane (e.g. a silicon backplane), and a detector matrix (e.g. a photodiode matrix) may be embedded in the backplane. A display may be formed from light emitting elements configured to emit visible light, i.e. light generally in around the 380-700 nm range. For example, a layer of organic materials may be deposited on top of the detector matrix to form an OLED display. The layer of organic materials may be patterned, and/or minute apertures may be formed in the organic layer such that the detectors in the detector matrix are exposed to the reflected light having the illumination wavelength. In a further example, the display may comprise microLEDs, which may be arranged in a same plane as the detector matrix.

Where the optoelectronic module comprises a display, such as the integrated detector and display layer illustrated in FIG. 3, it will be understood that it is advantageous that the mask layer 308 be transparent to visible light to prevent distortion or obstruction of the light from the display.

While the optoelectronic module 300 illustrated in FIG. 3 is illustrated as comprising a passive mask layer 308 (i.e. the processor 310 is not connected to the mask layer 308 in FIG. 3), the integrated detector and display layer may equally be implemented in an optoelectronic module 200 comprising an active mask layer 208, such as that illustrated in FIG. 2.

FIG. 4 illustrates a fourth example of an optoelectronic module 400 according to the present disclosure.

The optoelectronic module 400 illustrated in FIG. 4 comprises a mask layer 408. In the example illustrated in FIG. 4, an illuminator 402 is integrated with the detector layer 406 into a single layer. For example, the light sources 404 of the illuminator 402 may be distributed about the detector layer 406. For example, the light sources 404 may be distributed about a periphery of the detector layer 406. A processor 410 is connected to the integrated detector and illuminator and configured substantially similarly as described hereinabove.

Although the mask layer 408 illustrated in FIG. 4 is a passive mask layer 408 (i.e. the mask layer 408 is not connected to the processor 410), it will be appreciated that an active mask layer, such as illustrated in FIG. 2, may equally be implemented in the example of FIG. 4. Likewise, the detector layer 306 may be integrated with a display layer such as illustrated in FIG. 3 and described hereinabove, such that the display, detector layer 406, and illuminator 402 are all integrated as a single layer.

The mask layer 408 may be configured to enable transmission of the light having the illumination wavelength from the light sources 404 towards the scene. For example, the mask layer 408 may be sized such that the mask layer 408 does not cover the light sources 404, and/or may comprise transparent or transmissive portions (at the illumination wavelength) in the locations of the light sources 404.

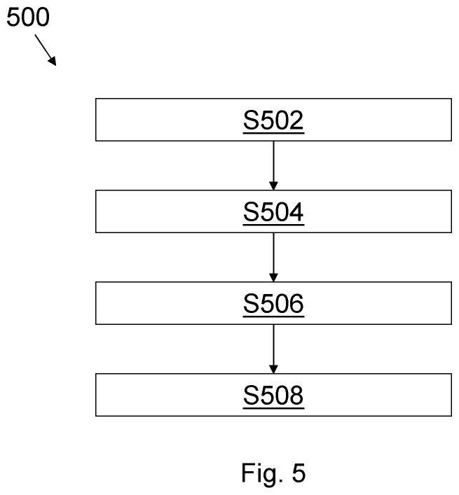

FIG. 5 illustrates an example of a method 500 of manufacturing an optoelectronic module according to the present disclosure.

According to the method 500 illustrated in FIG. 5, a step S502 comprises forming an illuminator, the illuminator comprising a plurality of light sources configured to emit light towards a scene at an illumination wavelength.

In some examples, the step S502 may comprise disposing the plurality of light sources about a periphery of the illuminator.

A step S504 comprises disposing a detector layer in the optoelectronic module, the detector layer being configured to detect light having the illumination wavelength reflected by the scene.

In some examples, forming the illuminator in the step S502 may comprise forming the illuminator S502 in the detector layer, for example as illustrated in FIG. 4 and described herein.

In some examples, the detector layer may be integrated with a display layer.

A step S506 comprises disposing a mask layer over the detector layer, the mask layer being configured to interact with light having the illumination wavelength.

A step S508 comprises configuring a processor to modulate the plurality of light sources and reconstruct an image of the scene.

In some examples, the method 500 may further comprise configuring the processor to control a controllable (or “active”) mask layer.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

### LIST OF REFERENCE NUMERALS

100, 200, 300, 400 Optoelectronic module
102, 202, 302, 402 Illuminator
104, 204, 304, 404 Light source
106, 206, 306, 406 Detector layer
108, 208, 308, 408 Mask layer
110, 210, 310, 410 Processor
500 Method of manufacturing an optoelectronic module
S502 Form an illuminator, the illuminator comprising a plurality of light sources configured to emit light towards a scene at an illumination wavelength.
S504

Dispose a detector layer in the optoelectronic module, the detector layer being configured to detect light having the illumination wavelength reflected by the scene.
S506 Dispose a mask layer over the detector layer, the mask layer being configured to interact with light having the illumination wavelength.
S508 Configure a processor to: modulate the plurality of light sources; and reconstruct an image of the scene.

1. An optoelectronic module comprising:
an illuminator comprising a plurality of light sources configured to emit light towards a scene at an illumination wavelength;
a detector layer configured to detect light having the illumination wavelength reflected by the scene;
a mask layer disposed over the detector layer, the mask layer being configured to interact with light having the illumination wavelength; and
a processor, the processor configured to:
modulate the plurality of light sources; and
reconstruct an image of the scene.

2. The optoelectronic module according to claim 1, wherein the illuminator is disposed over the mask layer.

3. The optoelectronic module according to claim 1, wherein the illuminator is integrated with the detector layer.

4. The optoelectronic module according to claim 1, wherein the plurality of light sources of the illuminator are disposed around a periphery of the optoelectronic module.

5. The optoelectronic module according to claim 1, wherein the detector layer is integrated with a display layer.

6. The optoelectronic module according to claim 1, wherein the mask layer is configured to be transmissive to visible light.

7. The optoelectronic module according to claim 1, wherein the illumination wavelength is an infrared wavelength.

8. The optoelectronic module according to claim 1, wherein the mask layer comprises a uniformly redundant array or a modified uniformly redundant array.

9. The optoelectronic module according to claim 1, wherein the mask layer comprises a controllable mask, and wherein the processor is further configured to control the controllable mask.

10. The optoelectronic module according to claim 9, wherein the controllable mask comprises one or more of:
a liquid crystal display;
a plurality of vanadium oxide transistors; and/or
a digital micromirror device.

11. The optoelectronic module according to claim 1, wherein the mask layer comprises a passive mask.

12. The optoelectronic module according to claim 1, wherein the processor is further configured to modulate each of the plurality of light sources individually.

13. The optoelectronic module according to claim 12, wherein the illuminator is configured to illuminate the scene sequentially at a plurality of different illumination angles, and wherein the processor is further configured to reconstruct a plurality of images of the scene, each image of the scene corresponding to a different illumination angle.

14. The optoelectronic module according to claim 13, wherein the processor is further configured to apply an iterative phase retrieval algorithm to the plurality of images of the scene, and further to generate a complex-valued object image of the scene.

15. The optoelectronic module according to claim 13, wherein the processor is further configured to determine a 3-dimensional reconstruction of the scene from the plurality of images.

16. The optoelectronic module according to claim 1, wherein the processor is further configured to:
determine an intensity of the light detected by the detector layer; and
vary a power of the plurality of light sources based on the intensity of the light detected by the detector layer.

17. A method of manufacturing an optoelectronic module, the method comprising:
providing an illuminator, the illuminator comprising a plurality of light sources configured to emit light towards a scene at an illumination wavelength;
disposing a detector layer in the optoelectronic module, the detector layer being configured to detect light having the illumination wavelength reflected by the scene;
disposing a mask layer over the detector layer the mask layer being configured to interact with light having the illumination wavelength; and
configuring a processor to:
modulate the plurality of light sources; and
reconstruct an image of the scene.
